(19) United States
(12) Patent Application Publication
(10) Pub. No.: US 2018/0029414 A1
(43) Pub. Date: Feb. 1, 2018

(54) AXLE BEAM WITH VARIABLE WALL THICKNESS AND VARIABLE CROSS-SECTIONAL SHAPE AND METHOD OF MAKING SAME

(71) Applicant: U.S. Manufacturing Corporation, Warren, MI (US)

(72) Inventors: Adel Mohd Khanfar, Sterling Heights, MI (US); Earl Paul Barker, II, St. Clair, MI (US); Dennis Bucholtz, St. Clair, MI (US)

(21) Appl. No.: 15/220,577

(22) Filed: Jul. 27, 2016

(51) Int. Cl. B60B 35/06; B60B 35/08

(52) U.S. Cl. CPC B60B 35/06; B60B 35/08; B60B 2310/211

(57) ABSTRACT

An axle beam comprises a hollow middle portion and a pair of hollow end portions. The hollow middle portion has a first corner-curved tapered arch cross-sectional shape. The pair of hollow end portions each have a substantially circular cross-sectional shape, and each extend from an opposite end of the middle portion. The hollow middle portion has a first wall thickness. The hollow end portions each have a second wall thickness that is larger than the first wall thickness.

### BACKGROUND

The present application relates generally to an axle beam. In particular, the present application relates to an axle beam having a variable wall thickness and a variable cross-sectional shape, and a method of making the same.

Generally speaking, axle beams are often subjected to significant loads in various applications. For example, vehicle axle beams can transmit significant torque to the vehicle wheels, and are often subjected to rapid starts and stops in operation. Because of the significant loads that are often imposed on vehicle axle beams, most axle beams have a solid construction to provide sufficient rigidity and strength to withstand these loads. Solid axle beams, however, require a significant amount of material and are relatively heavy. In vehicles, this additional weight can have a negative effect on fuel economy, and can impose additional loads on other vehicle components.

Because of the disadvantages associated with solid drive axle beams, hollow drive axle beams have been developed. Existing methods for forming hollow axle beams, however, make it difficult to quickly and efficiently manufacture multiple axle beams while varying the wall thicknesses and cross-sectional shapes of the beams to achieve the objectives of a particular application. In addition, most hollow axle beams have a uniform cross-sectional shape and thickness, which can result in unnecessary weight and poor weight optimization.

Thus, there is a need for an improved axle beam and a method of making the same that addresses one or more of the above noted deficiencies associated with conventional axle beams. These and other advantageous features will become apparent to those reviewing the present disclosure.

### SUMMARY

One embodiment relates to an axle beam comprising a hollow middle portion and a pair of hollow end portions. The hollow middle portion has a first corner-curved tapered arch cross-sectional shape. The pair of hollow end portions each have a substantially circular cross-sectional shape, and each extend from an opposite end of the middle portion. The hollow middle portion has a first wall thickness. The hollow end portions each have a second wall thickness that is larger than the first wall thickness.

Another embodiment relates to an axle beam assembly comprising an elongated middle portion, a pair of end portions, a pair of angular portions, and a pair of pivotable members. The elongated middle portion has a first hollow corner-curved tapered arch cross-sectional shape. The pair of end portions each have a hollow substantially circular cross-sectional shape, and each extend from an opposite end of the middle portion. The pair of angular portions are each disposed at opposite ends of the axle beam assembly between the middle portion and each of the end portions, respectively. The pair of angular portions each have a second hollow corner-curved tapered arch cross-sectional shape that is different from the first hollow corner-curved tapered arch cross-sectional shape. The pair of pivotable members are fixedly attached to the pair of end portions, respectively.

Yet another embodiment relates to a method of forming an axle beam. The method comprises forming a first wall thickness along a middle portion of an elongated tubular member. The method further comprises forming a second wall thickness along opposite end portions of the tubular member, where the first wall thickness is less than the second wall thickness, and where the middle portion is located between the two end portions. The method further comprises reducing an inside diameter at an outermost periphery of each of the end portions of the tubular member. The method further comprises forming a first corner-curved tapered arch cross-sectional shape along the middle portion and a second corner-curved tapered arch cross-sectional shape at least partially along each of the end portions.

### BRIEF DESCRIPTION OF THE DRAWINGS

FIG. 1 is a perspective view of an axle beam assembly according to an exemplary embodiment.

FIG. 2 is a front view of the axle beam assembly of FIG. 1.

FIG. 2A is a cross-sectional view taken along line 2A in FIG. 2.

FIG. 2B is a cross-sectional view taken along line 2B in FIG. 2.

FIG. 2C is a cross-sectional view taken along line 2C in FIG. 2.

FIG. 3 is a front view of a tubular member used to form an axle beam assembly according to an exemplary embodiment.

FIG. 4 is a side view of the tubular member of FIG. 3.

FIG. 5 is a front view of the tubular member of FIG. 3 after undergoing a first forming operation.

FIG. 5A is a cross-sectional view of the tubular member taken along line 5A in FIG. 5.

FIG. 5B is a cross-sectional view of the tubular member taken along line 5B in FIG. 5.

FIG. 6 is a front view of the tubular member of FIG. 5 after undergoing a second forming operation.

FIG. 6A is a cross-sectional view of the tubular member of FIG. 6 taken along line 6A.

FIG. 6B is a cross-sectional view of the tubular member of FIG. 6 taken along line 6B.

FIG. 6C is a cross-sectional view of the tubular member of FIG. 6 taken along line 6C.

FIG. 7 is a front view of the tubular member of FIG. 6 after undergoing a third forming operation.

FIG. 8A illustrates an assembly sequence for fixedly coupling a pair of pivotable members to the tubular member of FIG. 7.

FIG. 8B is a front view of a complete axle beam assembly according to an exemplary embodiment.

FIG. 9 is a flow chart illustrating a method of forming an axle beam assembly according to an exemplary embodiment.

### DETAILED DESCRIPTION

Referring generally to the FIGURES, disclosed herein is an axle beam assembly having a variable wall thickness and a variable cross-sectional shape. The disclosed axle beam assembly can withstand greater bending and torsional forces at specific areas along the axle beam, as compared to conventional vehicle axle beams, while improving weight distribution and reducing the overall weight of the axle beam assembly. In addition, disclosed herein is a method of forming an axle beam that allows for rapid and efficient production of multiple axle beams in a manufacturing environment.

Generally speaking, an axle beam assembly may include areas or portions that are subjected to lower levels of bending and torsional forces relative to other areas along the axle beam, such as in an automotive vehicle application. Thus, there is an opportunity for weight reduction and mass optimization along these areas of the axle beam. The axle beam assembly disclosed herein includes a variable wall thickness and a variable cross-sectional shape that can reduce the weight of the axle beam assembly, and can account for the different bending and torsional forces experienced along the axle beam in a typical automotive vehicle application. In this way, the axle beam assembly provides for improvements in weight optimization and overall weight reduction for a vehicle.

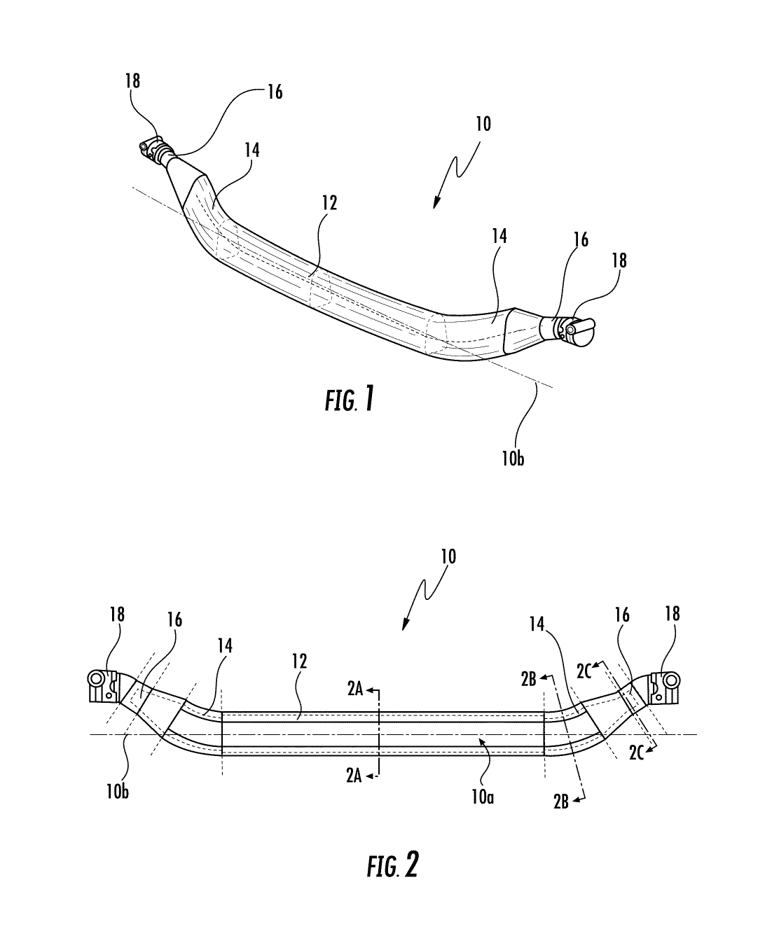

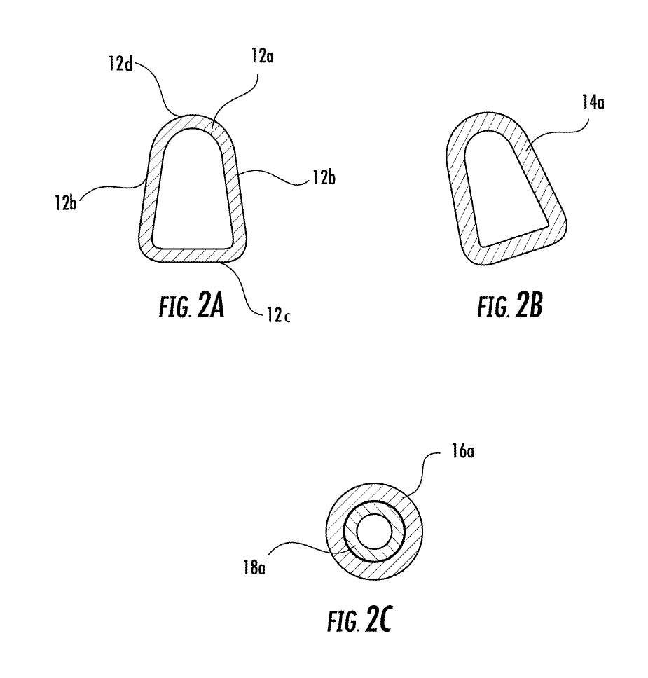

Referring to FIGS. 1-2C, an axle beam assembly 10 is shown according to an exemplary embodiment. In the exemplary embodiment shown, the axle beam assembly 10 is configured as a steerable, front axle beam for a wheeled vehicle, such as a car, a truck, or the like. However, it should be appreciated that the axle beam assembly 10 may be configured for use as a non-steerable axle beam or for use in other types of vehicles, such as motorized or non-motorized vehicles, according to other exemplary embodiments. According to an exemplary embodiment, the axle beam assembly 10 can be coupled to a vehicle chassis and can receive a vehicle wheel at opposite ends thereof. The axle beam assembly 10 may be used to transfer torque between a drive member and a driven member, such as from a vehicle drivetrain to one or more of the vehicle wheels. The axle beam assembly 10 can support at least a portion of the weight of the vehicle via the one or more vehicle wheels, according to an exemplary embodiment.

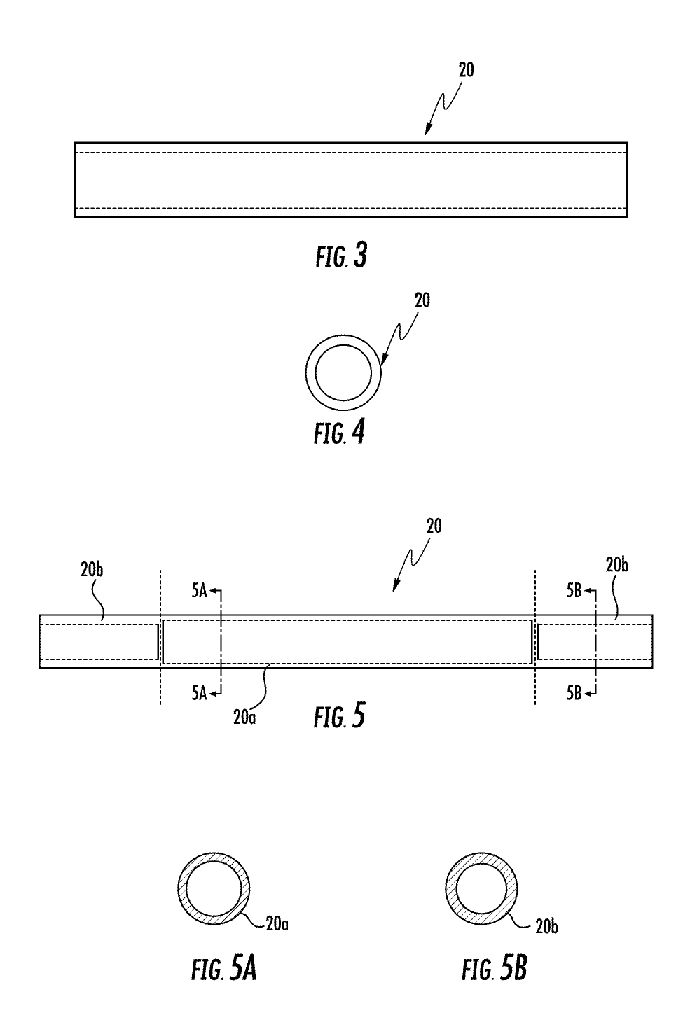

According to the exemplary embodiment of FIGS. 1-2C, the axle beam assembly 10 includes a middle portion 12 (e.g., a first section, a central portion, etc.), a pair of angular portions 14 (e.g., second sections, bent portions, elbows, etc.), a pair of end portions 16 (e.g., a third section, ends, etc.), and a pair of pivotable members 18 (e.g., king pin yokes, king pin members, etc.). As shown in FIGS. 1-2C, the middle portion 12, the pair of angular portions 14, and the pair of end portions 16 are integrally formed from a single tubular member (see, for example, FIG. 4) to define a unitary axle beam body. Each of the pivotable members 18 are coupled to the end portions 16 of the axle beam body, respectively. According to an exemplary embodiment, each pivotable member 18 is fixedly or removably coupled to an end portion 16, such as by welds, fasteners, or the like.

According to an exemplary embodiment, the axle beam body is formed from a single tubular member (e.g., hollow tubular blank, etc.) made from a conventional metal or metal alloy or combinations of metals and/or metal alloys. According to other exemplary embodiments, the axle beam body is formed from other rigid or semi-rigid materials or combinations of materials suitable for the particular application of the axle beam assembly 10. The details of forming the axle beam body are discussed in the paragraphs that follow.

As shown in FIGS. 1-2C, the axle beam body is tubular or hollow to reduce the weight of the axle beam assembly 10 relative to conventional solid axle beams. The axle beam body includes a bore 10a extending along the entire length of the body, according to an exemplary embodiment. The outer and/or inner diameters of the axle beam body may vary to define a wall of varying thickness. The axle beam body may also include a wall of varying cross-sectional shape along at least a portion of the length of the axle beam body. In this manner, the axle beam assembly 10 can accommodate for variations in loads experienced along the axle beam assembly 10, such as in an automotive vehicle application. It should be understood, however, that the variation in wall thickness and cross-sectional shape is exemplary only and may vary depending on the particular application of the axle beam assembly 10 to accommodate anticipated needs in terms of strength, packaging, or other parameters.

FIG. 2A is a cross-sectional view of the middle portion 12 taken along line 2A in FIG. 2. As shown in FIG. 2A, the middle portion 12 has a first cross-sectional shape referred to herein as a “corner-curved tapered arch” shape defined by a wall 12a. For example, the wall 12a includes a pair of tapered portions 12b each having a generally planar shape joined together at a first end by a generally planar portion 12c. The pair of tapered portions 12b are oriented at an acute angle relative to the generally planar portion 12c to define a generally tapered arch configuration. The pair of tapered portions 12b are also joined together at a second end opposite the first end by a curved corner 12d (e.g., arch portion, curved apex, arcuate corner, etc.). Each of the corners defined by the tapered portions 12b and the generally planar portion 12c has a generally curved shape. This “corner-curved tapered arch” cross-sectional shape, advantageously, minimizes the tensile stresses that may be experienced along a lower area of the middle portion 12 in, for example, an automotive vehicle application (e.g., due to the weight supported by the axle beam assembly, such as from power train components, vehicle chassis, etc.). According to an exemplary embodiment, the wall 12a can have a wall thickness of about 10 millimeters. According to other exemplary embodiments, the wall 12a may have a thickness of between about 6 millimeters to about 13 millimeters along at least a portion of the length or along the entire length of the middle portion 12.

Still referring to FIGS. 1-2C, the middle portion 12 extends to a pair of angular portions 14 at opposite ends thereof. The angular portions 14 are each oriented at an angle (see, for example, angle “A” in FIG. 7) of about thirty degrees relative to a center axis 10b defined by the bore 10a, according to an exemplary embodiment. According to other exemplary embodiments, the angular portions 14 may be oriented at a different angle, depending on the particular application of the axle beam assembly. The angular portions 14 can, advantageously, provide for suitable clearance of the middle portion 12 relative to vehicle power train components, such as an engine, a transmission, or the like. The angular portions 14 can each be formed by a bending operation, the details of which are discussed further below with reference to FIGS. 7 and 9. According to the exemplary embodiment shown in FIG. 2B, each of the angular portions 14 has a second corner-curved tapered arch cross-sectional shape defined by a wall 14a that has an outer shape or profile that is substantially the same as, or is similar to, the outer shape of the middle portion 12. According to an exemplary embodiment, the wall 14a along each of the angular portions 14 has a thickness that is up to 75% larger than the thickness of the wall 12a along the middle portion 12.

The difference in wall thickness between the middle portion 12 and the angular portions 14 results in a significant weight reduction of the axle beam assembly 10, as compared to conventional axle beams. In addition, the wall thickness at wall 12a can be less than the wall thickness at wall 14a, because the middle portion 12 experiences a lower amount of bending and torsional forces than each of the angular portions 14 in a typical automotive vehicle application. Furthermore, the first corner-curved tapered arch cross-sectional shape of the middle portion 12 allows for this reduction in wall thickness, while still maintaining sufficient strength and structural rigidity of the axle beam assembly 10 for the particular application thereof.

Referring to FIGS. 1-2C, the axle beam assembly 10 includes a pair of end portions 16 extending outwardly from each of the angular portions 14 to define outermost ends of the axle beam body. The angular portions 14 each taper inwardly toward a center axis 16b to each of the end portions 16. The end portions 16 each have a hollow, cylindrical shape and are oriented at the same angle as the angular portions 14, according to an exemplary embodiment. The end portions 16 are each configured to receive at least a portion of a pivotable member 18 therein. According to an exemplary embodiment, the pivotable member 18 can removably couple various components of a vehicle axle or wheel assembly to the axle beam assembly 10, such as a spindle, a wheel hub, a rotor, bushings, bearings, or the like.

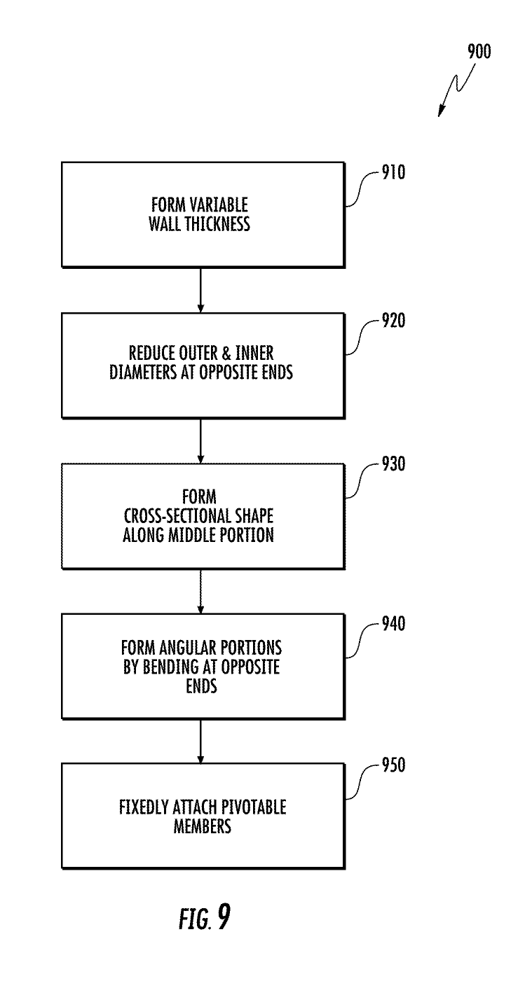

As shown in the cross-sectional view of FIG. 2C, the end portions 16 are defined by a wall 16a having a substantially circular cross-sectional shape, and a wall thickness of about 13 millimeters, according to an exemplary embodiment. According to other exemplary embodiments, the end portions 16 have a different cross-sectional shape, such as rectangular, oval, pentagonal, octagonal, or the like. As shown in the figures, the wall thickness of each the end portions 16 is substantially the same as the wall thickness along each of the angular portions 14. According to an exemplary embodiment, the end portions 16 have an outer diameter of about 90 millimeters. According to other exemplary embodiments, the outer diameter is limited to a maximum diameter that is prescribed by the outer geometry of middle portion 12, shown in FIG. 2A, whereas the minimum outer diameter can be no smaller than 88% of the maximum prescribed diameter. The end portions 16 couple the pivotable members 18 to the axle beam assembly 10. For example, as shown in FIG. 2C, each pivotable member 18 includes an elbow 18a, at least a portion or all of which is inserted into an end portion 16 at opposite ends of the axle beam assembly 10. According to an exemplary embodiment, each pivotable member 18 is fixedly attached to an end portion 16 via one or more welds at the elbow 18a (see, for example, FIG. 8B). According to other exemplary embodiments, the pivotable member 18 is fixedly or removably coupled to the end portion 16 via a press-fit interface or with other types of fasteners, such as bolts, screws, bonding agents, or the like.

Referring now to FIGS. 3-9, a method 900 of forming an axle beam assembly is shown according to an exemplary embodiment. In a first step shown in FIG. 3, a hollow, tubular member 20 (e.g., hollow member, tubular blank, etc.) is obtained. According to an exemplary embodiment, the hollow tubular member 20 is a round tubular piece of aluminum (e.g., billet aluminum, etc.) of a determined length, although it is appreciated that the tubular member may be made from a different material or combinations of materials suitable for the particular application of the axle beam assembly, according to other exemplary embodiments. The hollow tubular member 20 may be coated with a lubricant to facilitate forming or bending thereof.

According to the exemplary embodiment of FIGS. 5-5B and 9, the hollow tubular member 20 is subjected to a first forming operation (Step 910) to create a variable wall thickness along a length of the member 20. For example, as shown in FIG. 5, the hollow tubular member 20 is formed to have a first wall 22a along a middle portion thereof. The first wall 22a may be formed by reducing the outside diameter of the tubular member via forward extrusion through a round die orifice of a determined size, according to an exemplary embodiment. The hollow tubular member 20 can be further formed (Step 910) to have a second wall 24a having a different wall thickness than the first wall 22a along at least a portion of the tubular member 20 at opposite ends thereof (e.g., end portions 16, ends 26, etc.). According to an exemplary embodiment, the second wall 24a has a wall thickness that is larger than the wall thickness of the first wall 22a. According to an exemplary embodiment, the second wall 24a has a wall thickness that is up to 75% larger than the wall thickness of the first wall 22a. According to an exemplary embodiment, the length of the second wall 24a at each end is dependent upon the interface requirements for coupling or attaching the pivotable members 28 to the axle beam assembly (see, for example, FIGS. 8A-8B). The second wall 24a may be formed using a shoulder stepped mandrel that can provide a forming load at each end of the hollow tubular member 20, according to an exemplary embodiment. According to an exemplary embodiment, the first wall 22a may be formed via a compressive/tension forward extrusion cycle to create the desired wall thickness. In this manner, cross-sectional area reductions of at least about 60% or more can be achieved along the middle portion of the tubular member 20 relative to the end portions 16, thereby reducing the overall weight of the axle beam assembly.

Still referring to FIGS. 5-5B and 9, the use of a mandrel during the first forming operation (Step 910) to provide a variable wall thickness can result in relatively high temperatures at the mandrel. According to an exemplary embodiment, the high temperatures that may result from the first forming operation can be reduced or minimized by using a punch transfer mechanism and one or more cooling rings during the forming process. This can, advantageously, allow for a sufficient amount of time for the punch to cool to thereby maintain the useful life of the tool and to improve efficiency during the forming process.

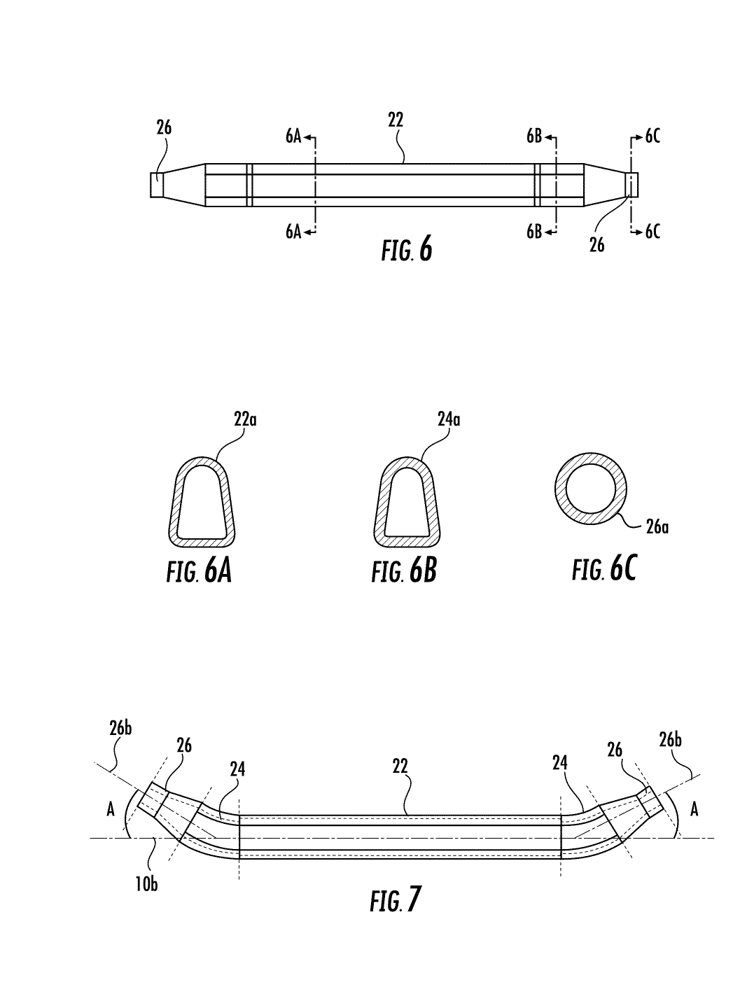

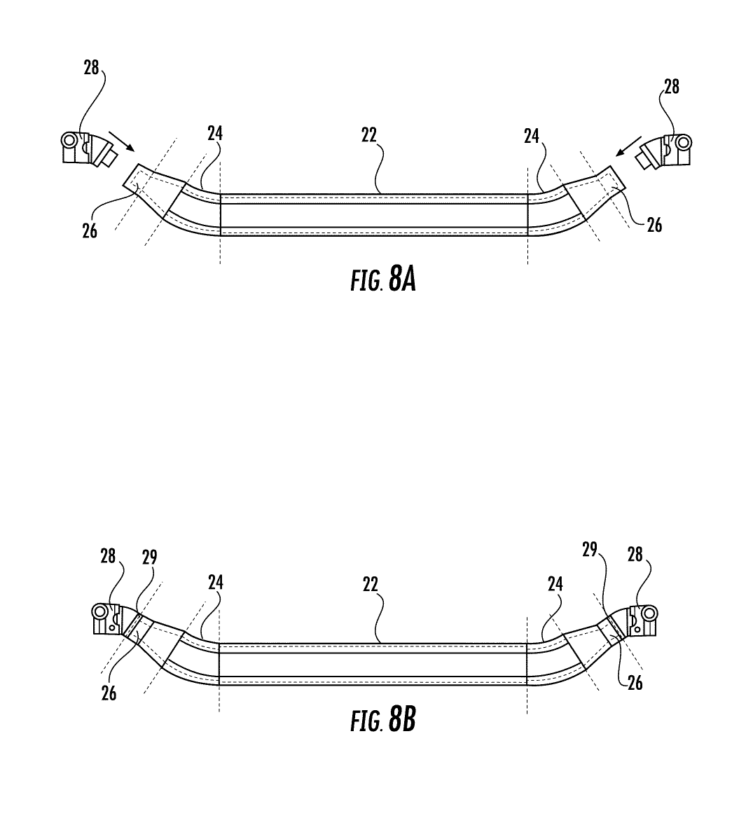

Referring now to FIGS. 6-6C and 9, the hollow tubular member 20 may be subjected to a second forming operation (Step 920) to provide a reduced outside diameter and inside diameter at opposite ends of the hollow tubular member 20. For example, the hollow tubular member 20 shown in FIG. 6 includes ends 26 (e.g., end portions, etc.) having an outer diameter and inner diameter that is smaller than the outer/inner diameters of the middle portion 22. The reduced diameters at the ends of the tubular member 20 can, advantageously, allow for coupling of pivotable members 28 thereto (see FIGS. 8A-8B). That is to say, each of the ends 26 has an inner diameter sufficient to receive a pivotable member 28 therein. According to an exemplary embodiment, the reduced diameters at the ends 26 are achieved by one or more swaging or forging operations. For example, the ends 26 can be constrained or reduced through a die having an orifice with a diameter that corresponds to the desired outer/inner diameters of the ends 26. As shown in FIG. 6, the second forming operation results in a tapered transition extending from the middle portion 22 to the outermost periphery of each of the ends 26. The length of the ends 26 along the tubular member 20 is dependent upon the interface requirements for coupling or attaching the pivotable members 28 (e.g., fastening requirements, welding requirements, etc.). According to an exemplary embodiment, the second forming operation (Step 920) occurs simultaneously at both ends 26 of the hollow tubular member 20, thereby improving manufacturing speed and efficiency.

Still referring to FIGS. 6-6C and 9, the hollow tubular member 20 can be subjected to a third forming operation (Step 930) in which the middle portion 22 is formed to have a variable cross-sectional shape. As shown in the embodiment of FIGS. 6A-6B, a first corner-curved tapered arch cross-sectional shape is formed along the first wall 22a and a second corner-curved tapered arch cross-sectional shape is formed along a portion of the second wall 24b at each end of the hollow tubular member 20. According to an exemplary embodiment, the first and second cross-sectional shapes are achieved by a pass-through forward forming process similar to swaging. For example, a four segmented die can be used to achieve the desired corner-curved tapered arch shape. According to an exemplary embodiment, the die can include a first segment for positioning the hollow tubular blank 20 such that the center line of the tubular blank 20 is located along the center of the forming orifice of the die. According to an exemplary embodiment, wire EDM and/or sink EDM die manufacturing processes can be used to create a second segment having a first portion including a round cross-sectional shape that transitions to a second portion having a generally tapered arch shape with a centerline that is offset from the centerline of the first portion. The center of the second portion can be positioned relative to the hollow tubular member 20 to maintain the straightness of the tubular member during the third forming operation. The die can further include a third segment to provide the die orifice land area. The third segment can be relatively short in length (e.g., about 4 millimeters to about 6 millimeters) and may require an axial alignment device to maintain its position relative to the die. The die can also include a fourth segment that is separate from the first, second and third segments. According to an exemplary embodiment, the fourth segment includes a secondary forming land that allows for final adjustments of the die to meet the dimensional requirements of the desired cross-sectional shape.

Referring to FIGS. 7 and 9, the hollow tubular member 20 can be subjected to a bending operation (Step 940) in which the ends 26 are bent at an angle “A” to create angular portions 24 between each of the ends 26 and the middle portion 22 of the tubular member 20. According to an exemplary embodiment, the angular portions 24 are bent at an angle “A” of about 30 degrees relative to the centerline of the middle portion 22. However, the angular portions 24 may be bent to a different angle depending on the particular application of the axle beam assembly. In this way, the axle beam assembly can provide sufficient clearance for vehicle powertrain components, such as an engine, a transmission, or the like.

Referring to FIGS. 8A-8B and 9, the formed axle beam can receive a pair of pivotable members 28 at the respective ends 26 of the axle beam assembly (Step 950). According to an exemplary embodiment, the pivotable members 28 are king pin members, which act as the main pivot for the steering assembly of, for example, a wheeled vehicle. The pivotable members 28 can be inserted into the respective openings defined by the inner wall 26a of each end 26. According to an exemplary embodiment, the pivotable members 28 can be fixedly attached to the ends 26 via welding at an interface 29. This location for attaching (e.g., welding, etc.) the pivotable members 28 is particularly advantageous, because the ends 26 typically experience a lower amount of load (e.g., bending, torsional, etc.), as compared to other areas of the axle beam body in a typical automotive vehicle application, such as along the middle portion 22. In this way, the pivotable members 28 can be securely coupled to the ends 26 without the need for additional materials required for strengthening, etc. According to other exemplary embodiments, the pivotable members 28 are fixedly attached or removably coupled to the ends 26 via a press-fit arrangement, one or more fasteners (e.g., bolts, pins, screws, etc.), bonding agents, or the like.

The axle beam assembly disclosed herein includes a variable wall thickness and a variable cross-sectional shape that can withstand greater bending and torsional forces along specific areas along the axle beam, while improving weight distribution and reducing the overall weight of the axle beam assembly. In addition, the method of forming the axle beam disclosed herein is efficient and allows for rapid production of multiple axle beams in a manufacturing environment.

As utilized herein, the terms “approximately,” “about,” “substantially”and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present application.

1. An axle beam, comprising:
a hollow middle portion having a first corner-curved tapered arch cross-sectional shape; and
a pair of hollow end portions each having a substantially circular cross-sectional shape and each extending from an opposite end of the middle portion;
wherein the hollow middle portion has a first wall thickness; and
wherein the hollow end portions each have a second wall thickness that is larger than the first wall thickness.

2. The axle beam of claim 1, further comprising a pair of angular portions disposed at opposite ends of the axle beam between the middle portion and the pair of hollow end portions, respectively;
wherein the pair of angular portions each have a second corner-curved tapered arch cross-sectional shape including the second wall thickness.

3. The axle beam of claim 2, wherein the angular portions and the pair of end portions are each oriented at an angle of about 30 degrees from the center of the hollow middle portion.

4. The axle beam of claim 1, further comprising a pair of pivotable members fixedly attached at the pair of end portions, respectively.

5. The axle beam of claim 4, wherein each of the end portions has an inner diameter that is complementary to an outer diameter of each of the pivotable members such that each pivotable member is at least partially received within the end portion.

6. The axle beam of claim 1, wherein the hollow middle portion tapers inwardly toward a center of each of the end portions at each end of the axle beam.

7. The axle beam of claim 1, wherein the second wall thickness is at least about 75% larger than the first wall thickness.

8. The axle beam of claim 1, wherein the hollow middle portion and the pair of hollow end portions are formed from a single tubular blank.

9. An axle beam assembly, comprising:
an elongated middle portion having a first hollow corner-curved tapered arch cross-sectional shape;
a pair of end portions each having a hollow substantially circular cross-sectional shape and each extending from an opposite end of the middle portion;
a pair of angular portions disposed at opposite ends of the axle beam assembly between the middle portion and each of the end portions, respectively, wherein the pair of angular portions each have a second hollow corner-curved tapered arch cross-sectional shape that is different from the first hollow corner-curved tapered arch cross-sectional shape; and
a pair of pivotable members fixedly attached to the pair of end portions, respectively.

10. The axle beam assembly of claim 9, wherein the middle portion has a first wall thickness, and wherein the pair of angular portions and the pair of end portions each have a second wall thickness that is larger than the first wall thickness.

11. The axle beam assembly of claim 10, wherein the second wall thickness is at least about 75% larger than the first wall thickness.

12. The axle beam assembly of claim 9, wherein the angular portions and the pair of end portions are each oriented at an angle of about 30 degrees from the center of the middle portion.

13. The axle beam assembly of claim 9, wherein each of the end portions has an inner diameter that is complementary to an outer diameter of each of the pivotable members such that each pivotable member is at least partially received within the end portion.

14. The axle beam assembly of claim 9, wherein the middle portion tapers inwardly toward the center of each of the end portions at each end of the axle beam.

15-20. (canceled)
